(19) United States
(12) Patent Application Publication
(10) Pub. No.: US 2025/0210334 A1
(43) Pub. Date: Jun. 26, 2025

(54) FOURIER TRANSFORM ION CYCLOTRON RESONANCE MASS SPECTROMETRY DETECTION METHOD FOR ACTIVE DISSOLVED ORGANIC MATTER

(71) Applicants: Shuchai GAN, Guangzhou (CN); Faming WANG, Guangzhou (CN); Qiuxia YANG, Guangzhou (CN); Jinge ZHOU, Guangzhou (CN)

(72) Inventors: Shuchai GAN, Guangzhou (CN); Faming WANG, Guangzhou (CN); Qiuxia YANG, Guangzhou (CN); Jinge ZHOU, Guangzhou (CN)

(21) Appl. No.: 18/932,334

(22) Filed: Oct. 30, 2024

(30) Foreign Application Priority Data
Dec. 21, 2023 (CN) 2023117738638

(51) Int. Cl. H01J 49/00; H01J 49/38

(52) U.S. Cl. CPC H01J 49/0031; H01J 49/0036; H01J 49/38

(57) ABSTRACT

An FT-ICR mass spectrometry detection method for active dissolved organic matter is disclosed, which relates to the technical field of active and low-abundance molecule detection. The detection method of the present disclosure includes the following steps: S1. injecting a sample to be tested into an atomizer; S2. setting detection parameters of the FT-ICR mass spectrometry and conducting a test, wherein a data aquisition size is set to 4 M to 8 M, a data processing size is set to 8 M to 16 M, and a starting mass-to-charge ratio is set to 50 to 200; an optimal effect is achieved among the three through a parameter matching strategy, and the discrimination and detection throughput of different samples is significantly improved although low concentration samples are used; and S3. obtaining a mass spectrum and quasi-molecular ion peaks. According to the detection method of the present disclosure, a higher-throughput active dissolved organic matter fingerprint spectrum can be effectively output, and thus solving the problems in the prior art of difficult determination of active and low-abundance molecules, unclear key parameters, lack of parameter adaptation strategies and insufficient discrimination between different samples.

### CROSS-REFERENCE TO RELATED APPLICATION

The present disclosure is based on and claims the benefit of and priority to Chinese Patent Application No. 202311773863.8, filed on Dec. 21, 2023, the entire contents of which are incorporated herein by reference.

### TECHNICAL FIELD

The present disclosure relates to the technical field of active and low-abundance molecule detection, in particular to a Fourier transform ion cyclotron resonance (FT-ICR) mass spectrometry detection method for active dissolved organic matter.

### BACKGROUND

Dissolved organic matter (DOM) is a complex mixture ubiquitous in water, soil and sediment systems. DOM serves as an important bridge and rapid turnover reservoir in the global carbon cycle, and its specific composition determines the final storage form of carbon. In addition, because DOM is highly sensitive to environmental changes, a DOM fingerprint has become an effective indicator for judging historical land use conditions. However, the current understanding of DOM at the molecular level is still limited. DOM is highly heterogeneous and may contain thousands to tens of thousands of compounds as well as unknown geopolymers like humus, so it is difficult to accurately characterize the components of DOM using the conventional chromatography. By conducting UV-visible spectrum absorption, fluorescence characteristics analysis, C/N ratio and isotope testing on DOM, the overall condition of most DOM can be learned. Fourier transform ion cyclotron resonance mass spectrometry (FT-ICR-MS) technology can simultaneously determine the molecular components of DOM at the molecular level, and with its high resolution and high mass accuracy, can accurately identify the ratio of elements including C, H, O, N, P and S. To analyze the components of organic matter in complex matrices, ultra-high resolution mass spectrometry, including electrospray ionization (ESI) combined with Fourier transform ion cyclotron resonance mass spectrometry (FT-ICR-MS) is currently commonly used. However, the equipment is expensive, the parameter settings are extremely complex, and there are few related parameter debugging strategies and methods. With the wider application of ESI-FT-ICR-MS data in environmental and geological research, it becomes increasingly important to understand how to use this technology correctly. Although the standardized methods for testing are described in the prior art, it is still unknown how the most critical parameters that affect resolution jointly affect the ion peaks of the mass spectrometry. In particular, there is a lack of an optimal parameter co-detection method.

Specifically, the current FT-ICR mass spectrometry parameter detection method has the following technical problems: (1) active molecule signals cannot be effectively captured due to selective loss in pre-treatment; (2) due to the large difference between peak heights of the quasi-molecular ion peaks of dissolved organic matter, there is a problem of instability in low-intensity signal detection, making it difficult to compare the results of the same sample between different laboratories; (3) since the parameter settings of FT-ICR-MS are extremely complex, it is still unclear how to grasp and debug the key parameters; and (4) the difference between DOM after solid-phase extraction pre-treatment is very small, so it is very important to distinguish the variance of DOM components to obtain key signals and signal differences with discrimination. Furthermore, inappropriate parameters may result in the lost of components or incorrect molecular formulas.

In summary, the existing method has three technical problems that need to be solved urgently: difficult determination of active and low-abundance molecules, unclear key parameters, and insufficient discrimination between different samples.

### SUMMARY

The present disclosure aims to solve at least one of the above technical problems existing in the prior art. To this end, an objective of the present disclosure is to provide an FT-ICR mass spectrometry detection method for active dissolved organic matter, which achieves high-throughput detection of low-abundance and active component signals by selecting a data aquisition size, a data processing size and a mass-to-charge ratio that match each other.

In order to achieve the above objective, the technical solution used in the present disclosure is as follows.

The present disclosure provides an FT-ICR mass spectrometry detection method for active dissolved organic matter, including the following steps:

S1, injecting a sample to be tested into an atomizer;

S2, setting detection parameters of the FT-ICR mass spectrometry, and conducting a test, wherein a data aquisition size is set to 4 M to 8 M, a data processing size is set to 8 M to 16 M, and a starting mass-to-charge ratio is set to 50-200; and

S3, obtaining a mass spectrum and quasi-molecular ion peaks.

In the present disclosure, a data aquisition size is defined and a matching data processing size is selected to ensure that the peak profile and smoothness are close. Meanwhile, a starting mass-to-charge ratio that matches the data aquisition size and the data processing size is selected to ensure consistent resolution. By adjusting the data aquisition size, the data processing size and the starting mass-to-charge ratio, the resolution is exactly optimal. On the one hand, the situation where low-abundance signals are masked by noise is completely prevented; and on the other hand, because too high resolution is not used, the problem that signals cannot be effectively accumulated during the drift process is avoided.

In addition, due to the use of a specific parameter matching strategy which conforms to the active dissolved organic matter in the present disclosure, the detectability of active components is greatly increased, and comparison of results between laboratories is enabled. Since the parameter settings of FT-ICR-MS are extremely complex, it is still unclear how to grasp and debug the key parameters. In the present disclosure, the key parameters that affect the ion peak are selected, preventing the problem that the results of different laboratories cannot be recognized due to too complicated instrument debugging. Meanwhile, by means of the detection method of the present disclosure, the stability of low-intensity signals can be improved, which helps to improve the parallelism of samples.

By using the detection method of the present disclosure, high-throughput detection of active molecular signals that are difficult to effectively capture due to selective loss in pre-treatment may be achieved, allowing the method to simultaneously detect active and inert organic carbon components, thereby truly establishing a bridge between a microbial carbon pump precursor and an end product.

In addition, by means of the detection method of the present disclosure, the difference between DOM can be improved. Therefore, the variance for distinguishing DOM components is improved, key signals and signal differences with discrimination are obtained, and the problem of being unable to distinguish the true differences between samples due to a large number of similar signals is avoided. Moreover, by adjusting the data aquisition size, data processing size and starting mass-to-charge ratio that match each other, the shift of the mass-to-charge ratio is reduced, the half-peak width is reduced, the position of the peak is determined more accurately, and lost components or incorrect molecular formulas are reduced.

Therefore, by means of the detection method of the present disclosure, three problems existing in the prior art are at least solved: 1. difficult determination of active and low-abundance molecules; 2. unclear key parameters; and 3. insufficient discrimination between different samples.

In some embodiments of the present disclosure, the sample to be tested in the step S1 is obtained from at least one of water, soil and sediment.

In some embodiments of the present disclosure, the sample to be tested in the step S1 is one of humic acid, interstitial water and seawater.

The interstitial water is the water in the voids of soil or water body substrate that is not absorbed by soil particles and can move.

In some embodiments of the present disclosure, the humic acid is a humic acid standard sample of IHSS; and the interstitial water is mangrove interstitial water.

In some specific embodiments of the present disclosure, the sample to be tested in the step S1 comprises at least one of CHO, CHON, CHOS and CHOP.

In some embodiments of the present disclosure, the sample to be tested in the step S1 has an initial concentration of 21 mgC/L to 22 mgC/L.

In some embodiments of the present disclosure, the sample to be tested in the step S1 has an initial concentration of 20 mgC/L.

In some embodiments of the present disclosure, the sample to be tested in the step S1 is injected into the atomizer at a syringe flow rate of 195 μL/h to 205 μL/h.

In some embodiments of the present disclosure, the sample to be tested in the step S1 is injected into the atomizer at a syringe flow rate of 200 μL/h.

In some embodiments of the present disclosure, a gas pressure of the atomizer in the step S1 is set to 0.7 bar to 0.9 bar.

In some embodiments of the present disclosure, the gas pressure of the atomizer in the step S1 is set to 0.8 bar.

In some embodiments of the present disclosure, operating conditions of a dry gas in the atomizer of step S1 are 195° C. to 205° C., and 3 L/min to 5 L/min.

In some embodiments of the present disclosure, the operating conditions of the dry gas in the atomizer in the step S1 are 200° C., and 4 L/min.

In some embodiments of the present disclosure, the test in the step S2 is a purge operation.

In some embodiments of the present disclosure, the data aquisition size in the step S2 is 7 M to 8 M.

In some embodiments of the present disclosure, the data aquisition size in the step S2 is 8 M.

In some embodiments of the present disclosure, the data processing size in the step S2 is 15 M to 16 M.

In some embodiments of the present disclosure, the data processing size in the step S2 is 16 M.

In some embodiments of the present disclosure, the starting mass-to-charge ratio in the step S2 is 53 m/z to 193 m/z, for example, 53 m/z, 100 m/z, or 193 m/z.

In some embodiments of the present disclosure, the starting mass-to-charge ratio in the step S2 is 53 m/z to 100 m/z.

In some specific embodiments of the present disclosure, the starting mass-to-charge ratio in the step S2 is 53 m/z to 60 m/z.

In some specific embodiments of the present disclosure, the starting mass-to-charge ratio in the step S2 is 53 m/z to 55 m/z.

In some embodiments of the present disclosure, the starting mass-to-charge ratio in the step S2 is 53 m/z.

In the step S2 of the present disclosure, the starting mass-to-charge ratio is set to a low value, and the matching data aquisition size is set to 8 M accordingly. Meanwhile, based on the set value of 8 M of the data aquisition size, the data processing size is set to 16 M, so that the starting mass-to-charge ratio, data aquisition size and data processing size are optimally matched and combined, further improving the detection effect.

In some embodiments of the present disclosure, an instantaneous duration of a single scan in the test in the step S2 is 1.5 s to 2.5 s.

The influence of the instantaneous duration on the data is not linearly related directly, but depends on the settings of the starting mass-to-charge ratio, data aquisition size, and data processing size. Moreover, in the detection method of the present disclosure, the starting mass-to-charge ratio, data aquisition size, and data processing size are defined, so a range of the instantaneous duration can also be determined.

In some embodiments of the present disclosure, the instantaneous duration is 2 s.

In some embodiments of the present disclosure, a sweep excitation voltage in the test in the step S2 is 17% to 23%.

The sweep excitation voltage in the test in the step S2 is a sweep excitation voltage in the purge operation.

In some embodiments of the present disclosure, the data aquisition in the step S2 is conducted through mass spectrometry; and a mode of the data aquisition is a broadband mode.

In some embodiments of the present disclosure, the broadband mode has a scanning range of 50 m/z to 1000 m/z.

In some specific embodiments of the present disclosure, the broadband mode has a scanning range of 53 m/z to 1000 m/z.

In some embodiments of the present disclosure, the test in the step S2 is scanned for 16 times to 200 times.

In some embodiments of the present disclosure, the test in the step S2 has a capillary voltage of 4 kV to 5 kV.

In some embodiments of the present disclosure, each scan in the test has an ion accumulation time of 0.02 s to 0.08 s.

In some specific embodiments of the present disclosure, each scan in the test has an ion accumulation time of 0.02 s to 0.04 s.

In some embodiments of the present disclosure, during the test in the step S2, a peak profile is viewed by using a debugging mode to prevent branching.

In some embodiments of the present disclosure, the mass spectrum is externally calibrated with sodium trifluoroacetate.

In some embodiments of the present disclosure, the FT-ICR mass spectrometry detection method for active dissolved organic matter further comprises an operation for a secondary verification of if there is an overload in a total ion flow of an ion source and/or an operation for peak branching debugging between the step S2 and the step S3.

In some embodiments of the present disclosure, step S3 further comprises deriving the quasi-molecular ion peaks for data correction and molecular formula analysis.

In some embodiments of the present disclosure, the data correction is performed using a standard peak of the sample to be tested.

In some embodiments of the present disclosure, the data correction is performed using a standard peak of humic acid, interstitial water or seawater correspondingly.

In some embodiments of the present disclosure, the standard peak of humic acid used for data correction is a standard peak of humic acid of IHSS.

In some embodiments of the present disclosure, the FT-ICR mass spectrometry

parameter detection method for active dissolved organic matter includes the following steps:

S1, injecting a sample into an atomizer at a syringe flow rate of 195 μL/h to 205 μL/h, wherein the sample has an initial concentration selected as 21 mgC/L to 22 mgC/L.

S2, setting detection parameters of the FT-ICR mass spectrometry, and then conducting a test, during which a peak profile is viewed by using a debugging mode to prevent branching, wherein a data aquisition size is set to 4 M to 8 M, a data processing size is set to 8 M to 16 M, and a starting mass-to-charge ratio is set to 50 m/z to 200 m/z; and a sweep excitation power is set to 17% to 23%.

Because ion sources of different instruments may be different in contamination conditions, and the total ion flow entering the ion source is also different, a secondary verification is required to determine if there is an overload; a time is set to 0.03 s, which can be adjusted upward without causing an overload;

S3, obtaining a mass spectrum, and deriving quasi-molecular ion peaks; performing data correction using a standard peak, wherein the standard peak is a standard peak corresponding to a corresponding sample; and performing molecular formula analysis using software.

Compared with the prior art, the present disclosure at least has the following beneficial effects.

The present disclosure provides an FT-ICR mass spectrometry detection method for active dissolved organic matter, which can improve the detection throughput and reproducibility of active and low-abundance molecules, and achieve the reproduction of low-abundance signals by matching key parameters. Moreover, by means of the detection method of the present disclosure, the detection capability of active dissolved molecule signals is improved, thus the discrimination of different samples is significantly improved, higher-throughput active dissolved organic matter fingerprint spectra can be effectively output, the problem that it is difficult to distinguish the spectra due to the similarity of inert components can be prevented, and active and inert organic carbon components can be detected simultaneously.

### BRIEF DESCRIPTION OF DRAWINGS

FIG. 1 is a diagram showing quasi-molecular ion peaks of inert-component obtained using the method provided in an example of the present disclosure (at 369 m/z), wherein panel (a) is a spectrum before culture, and panel (b) is a spectrum after culture.

FIG. 2 is a diagram showing quasi-molecular ion peaks of active-component obtained using the method provided in an example of the present disclosure (at 369 m/z), wherein panel (a) is a spectrum before culture, and panel (b) is a spectrum after culture.

FIG. 3 is a diagram of quasi-molecular ion peaks obtained at different data aquisition sizes by means of the method provided in Example 1 of the present disclosure, wherein panel (a) is a spectrum obtained at a data aquisition size of 4 M; panel (b) is a spectrum obtained at a data aquisition size of 8 M; and panel (c) is a spectrum obtained at a data aquisition size of 16 M.

FIG. 4 is a diagram showing the difference in peak intensity and resolution obtained by means of the method provided in Example 1 of the present disclosure, wherein panel (a) is a diagram showing the influence of data aquisition size on ion intensity, panel (c) is a diagram showing the influence of data aquisition size on resolution, with a starting mass-to-charge ratio of 53, panel (b) is diagram showing the influence of the starting mass-to-charge ratio on ion intensity, and panel (d) is a diagram showing the influence of the starting mass-to-charge ratio on resolution, with a data aquisition size of 4 M.

FIG. 5A is a diagram showing the influence of data aquisition sizes on mass-to-charge ratio ranges in the method provided in Example 1 of the present disclosure, wherein the data aquisition sizes from left to right are 4 M, 8 M, and 16 M, respectively; and FIG. 5B is a diagram showing the difference in molecule species in the method provided in Example 1 of the present disclosure.

FIG. 6A is a diagram showing the influence of instantaneous duration of a single scan on average resolution in the method provided in Example 1 of the present disclosure, wherein the peak value of sample is more than 4000; and FIG. 6B is a diagram showing the influence of instantaneous duration of a single scan on average signal intensity, wherein the solid points in the diagram represent the debugging resolution based on the change of data aquisition sizes under the same starting mass-to-charge ratio, and the hollow points represent the debugging resolution based on the starting mass-to-charge ratio under the same data aquisition size, and the peak value of sample is more than 4000.

FIG. 7 is an effect diagram of different data processing sizes in the method provided in Example 1 of the present disclosure.

FIG. 8A and FIG. 8B are Van Krevelen diagrams of the method provided in Example 1 of the present disclosure, that is, a VK diagram, where FIG. 8A shows a signal change of the data aquisition size of 8 M vs. 4 M; and FIG. 8B shows a signal change of the data aquisition size of 8 M vs. 16 M.

FIG. 9 is a diagram showing the quasi-molecular ion peaks of mangrove interstitial water obtained by means of the method provided in Example 2 of the present disclosure, wherein panel (a) is a diagram of quasi-molecular ion peaks obtained at a data aquisition size of 4 M, panel (b) is a diagram of quasi-molecular ion peaks obtained at a data aquisition size of 8 M, and panel (c) is a diagram of quasi-molecular ion peaks obtained at a data aquisition size of 16 M, the middle molecular weight interval represents 369 m/z.

FIG. 10 is a diagram showing the quasi-molecular ion peaks of mangrove interstitial water obtained by means of the method provided in Example 2 of the present disclosure, wherein panel (a) is a diagram of quasi-molecular ion peaks obtained at a starting mass-to-charge ratio of 53, panel (b) is a diagram of quasi-molecular ion peaks obtained at a starting mass-to-charge ratio of 100, and panel (c) is a diagram of quasi-molecular ion peaks obtained at a starting mass-to-charge ratio of 193, the middle molecular weight interval represents 369 m/z.

FIG. 11 is a diagram showing the quasi-molecular ion peaks of mangrove interstitial water obtained by means of the method provided in Example 2 of the present disclosure, wherein panel (a) is a diagram of quasi-molecular ion peaks obtained at a data aquisition size of 4 M, panel (b) is a diagram of quasi-molecular ion peaks obtained at a data aquisition size of 8 M, and panel (c) is a diagram of quasi-molecular ion peaks obtained at a data aquisition size of 16 M, the middle molecular weight interval represents 463 m/z.

FIG. 12 is a diagram showing the quasi-molecular ion peaks of seawater obtained by means of the method provided in Example 3 of the present disclosure, wherein panel (a) is a diagram of quasi-molecular ion peaks obtained at a data aquisition size of 4 M, panel (b) is a diagram of quasi-molecular ion peaks obtained at a data aquisition size of 8 M, and panel (c) is a diagram of quasi-molecular ion peaks obtained at a data aquisition size of 16 M, the small molecular weight interval represents 215 m/z.

FIG. 13 is a diagram showing the quasi-molecular ion peaks seawater obtained by means of the method provided in Example 3 of the present disclosure, wherein panel (a) is a diagram of quasi-molecular ion peaks obtained at a data aquisition size of 4 M, panel (b) is a diagram of quasi-molecular ion peaks obtained at a data aquisition size of 8 M, and panel (c) is a diagram of quasi-molecular ion peaks obtained at a data aquisition size of 16 M, the large molecular weight interval represents 501 m/z.

FIG. 14 is a diagram showing the quasi-molecular ion peaks of seawater obtained by using different types of instruments by means of the method provided in Example 4 of the present disclosure, with a mass spectrum in which the magnetic field is changed from 7 T to 9.4 T, wherein panel (a) is a diagram of quasi-molecular ion peaks obtained at a data aquisition size of 4 M, panel (b) is a diagram of quasi-molecular ion peaks obtained at a data aquisition size of 8 M, and panel (c) is a diagram of quasi-molecular ion peaks obtained at a data aquisition size of 16 M.

FIG. 15 is a diagram showing the quasi-molecular ion peaks of seawater obtained by using different types of instruments by means of the method provided in Example 4 of the present disclosure, with a mass spectrum in which the magnetic field is changed from 7 T to 9.4 T, wherein panel (a) is a diagram of quasi-molecular ion peaks obtained at a starting mass-to-charge ratio of 53, panel (b) is a diagram of quasi-molecular ion peaks obtained at a starting mass-to-charge ratio of 100, and panel (c) is a diagram of quasi-molecular ion peaks obtained at a starting mass-to-charge ratio of 193.

FIG. 16 is a flowchart of the FT-ICR mass spectrometry detection method for active dissolved organic matter.

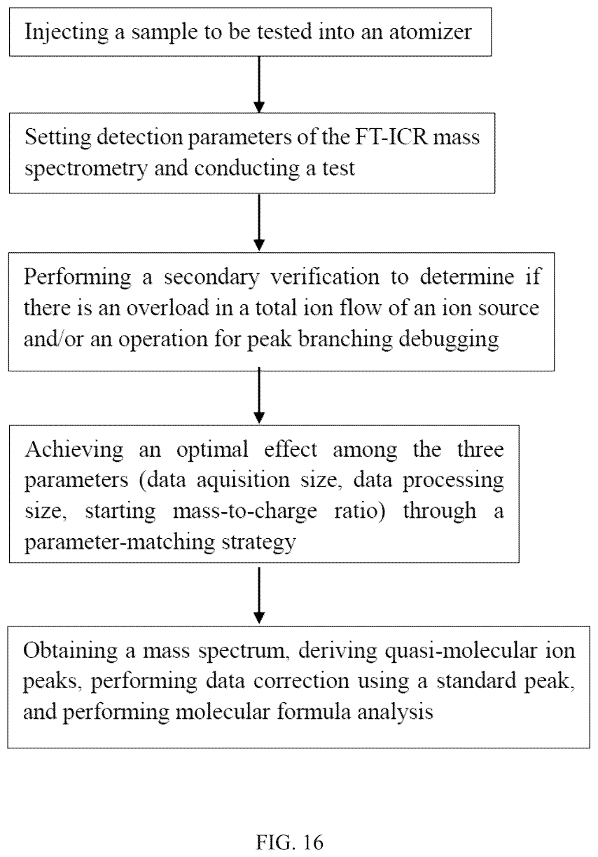

### DETAILED DESCRIPTION

The content of the present disclosure will be further described in detail below through specific examples. Unless otherwise stated, the raw materials, reagents or devices used in the examples and comparative examples can all be obtained from conventional commercial sources, or can be obtained through existing technical methods. Unless otherwise stated, experimental or test methods are conventional methods in the art.

### Example 1

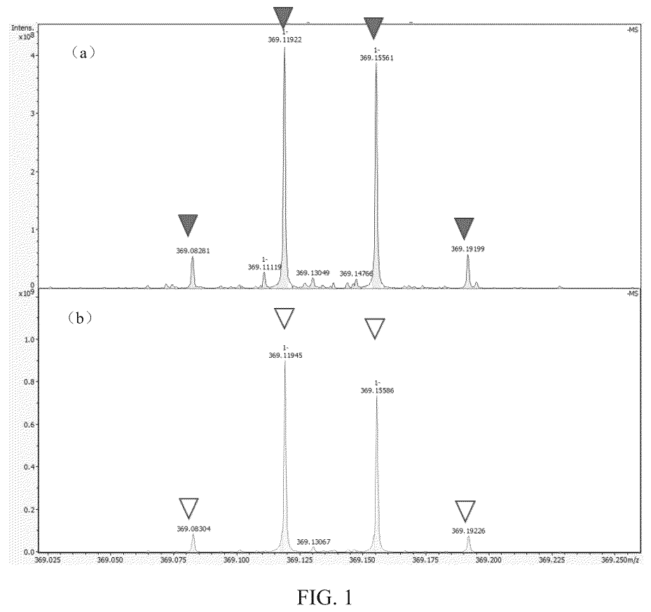

This example provided an FT-ICR mass spectrometry detection method for active dissolved organic matter. Referring to FIG. 1, the method included the following steps:

S1, a sample was injected into an atomizer at a syringe flow rate of 200 μL/h, wherein the sample had an initial concentration selected as 20 mg/L.

S2, various parameter values were set, and a test was then conducted, during which a peak profile was viewed by using a debugging mode to prevent branching, wherein a data aquisition size was set to 2 M to 16 M, a data processing size was set to 8 M to 32 M, and a starting mass-to-charge ratio was set to 53 m/z to 193 m/z.

S3, because ion sources of different instruments may be different in contamination conditions, and the total ion flow entering the ion source may be also different, a secondary verification was required to determine if there was an overload, and the time was set to 0.03 s.

S4, a mass spectrum was obtained, and quasi-molecular ion peaks were derived; data correction was performed using a standard peak of humic acid of IHSS; molecular formula analysis was performed using proprietary software “Toolkit”, H/C and O/C values were calculated, and a Van Krevelen (VK) diagram was drawn.

In this example, the mass spectrum was externally calibrated with sodium trifluoroacetate (TFA); the sample in step S1 was a humic acid standard sample of IHSS; in step S1, a gas pressure of the atomizer was set to 0.8 bar, and operating conditions of dry gas were 200° C., 4 L/min; the test in step S2 was scanned for 200 times, ta capillary voltage was 4.5 kV, each scan had a ion accumulation time of 0.03 s, and a sweep excitation power of the purge was 18%; the data aquisitio was implemented through mass spectrometry; a mode of the data aquisitio was a broadband mode (53 m/z to 1000 m/z); the mass spectrometry was in the type of FT-ICR-MS (solariX XR, Bruker Daltonics Inc.), scanning was performed in a negative ion mode, was equipped with an electrospray ionization (ESI) source, and had a magnet of 7 T. Meanwhile, for verification of the method, this example was conducted again on FT-ICR-MS having a magnet of 9.4 T.

The results of Example 1 of the present disclosure will be described in detail below in conjunction with FIG. 1 to FIG. 8.

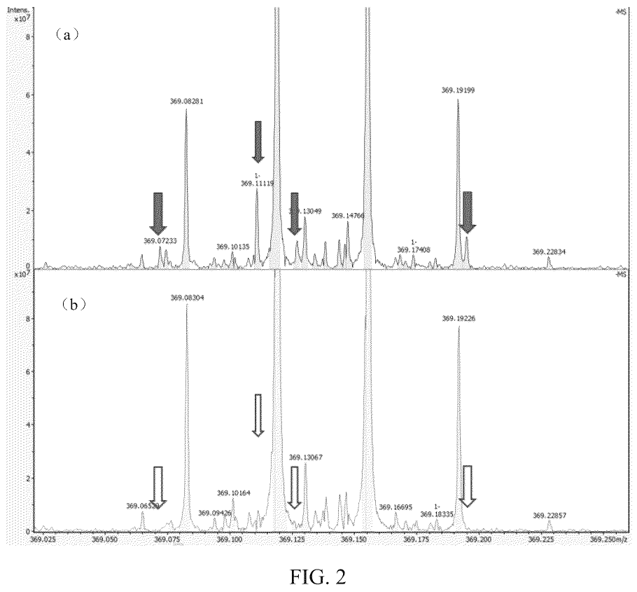

FIG. 1 is a diagram showing quasi-molecular ion peaks of inert-component obtained using the method provided in Example 1 of the present disclosure (at 369 m/z); and FIG. 2 is a diagram showing quasi-molecular ion peaks of active-component obtained using the method provided in Example 1 of the present disclosure (at 369 m/z). According to the results shown in FIG. 1 and FIG. 2, in the present disclosure, changes of DOM in water before and after microbial culture (i.e., water microcosm culture) in natural water was first tested, and it was found that the components with stronger signals did not change significantly during the culture, while components that underwent degradation had lower ion peak intensities, indicating that the key to detect active dissolved organic matter was the detection of low-abundance signals.

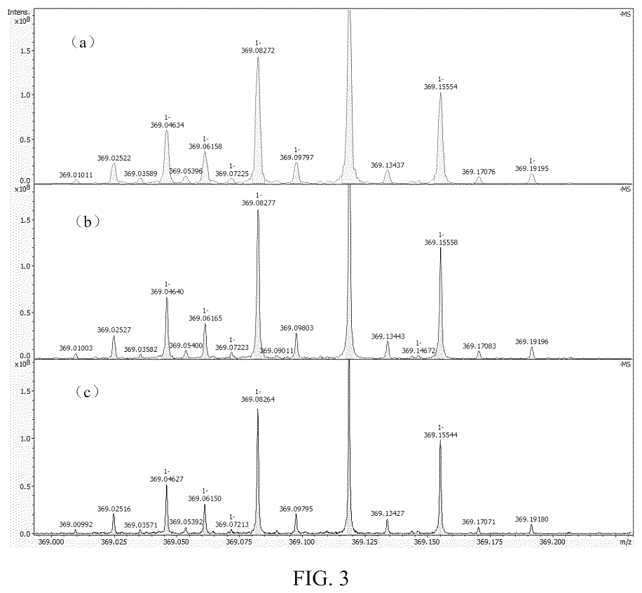

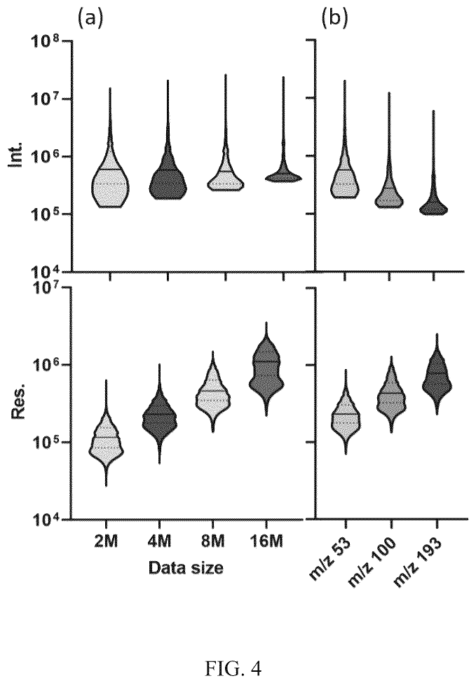

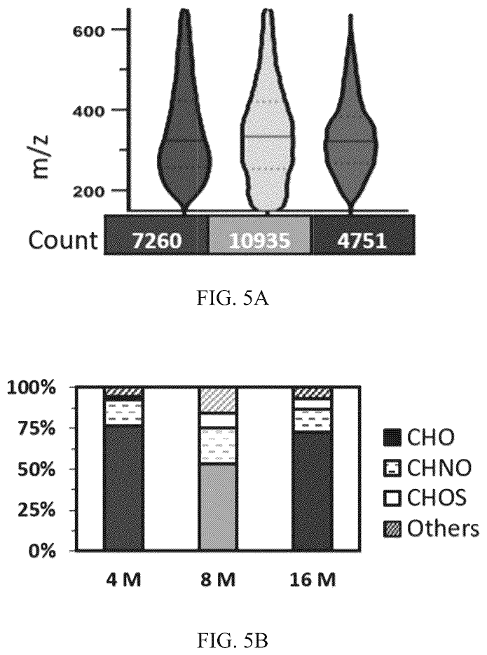

FIG. 3 is a diagram of quasi-molecular ion peaks obtained at different data aquisition sizes by means of the method provided in Example 1 of the present disclosure; FIG. 4 is a diagram showing the difference in peak intensity and resolution obtained by means of the method provided in Example 1 of the present disclosure; and FIG. 5A is a diagram showing the influence of data aquisition sizes on mass-to-charge ratio ranges in the method provided in Example 1 of the present disclosure; and FIG. 5B is a diagram showing the difference in molecule species in the method provided in Example 1 of the present disclosure. According to the comparison results of characterization methods in FIG. 3, FIG. 4, FIG. 5A and FIG. 5B, it is found that an optimal starting mass-to-charge ratio is 53 m/z, and an optimal data aquisition size is 8 M.

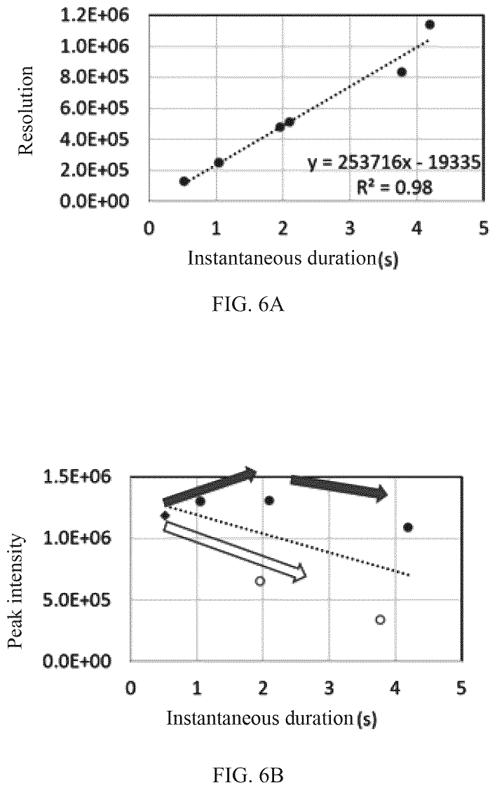

FIG. 6A and FIG. 6B are diagrams showing influence of the instantaneous duration of a single scan in the method provided in Example 1 of the present disclosure, 16 scans being performed. As can be seen from FIG. 6A and FIG. 6B, although the instantaneous duration has a significant linear correlation with the average resolution, the influence of the instantaneous duration on the average signal intensity is not linear, that is to say, the resolution cannot directly improve the signal intensity. The results of debugging resolution based on changes in data aquisition sizes at the same low mass-to-charge ratio show that the average signal density is the strongest at 8 M; and the results of debugging resolution based on the starting mass-to-charge ratio at the same data aquisition size show that although the increase in the starting mass-to-charge ratio improves the resolution, the defects are more obvious and the peak intensity decreases significantly. Therefore, a low starting mass-to-charge ratio is selected, and it is determined that the optimal data aquisition size is 8 M and data processing size is 16 M.

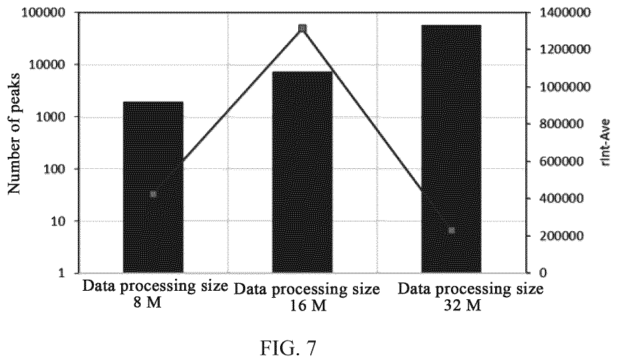

FIG. 7 is an effect diagram of different data processing sizes in the method provided in Example 1 of the present disclosure. As can be seen from FIG. 7, the optimal data processing size is 16 M.

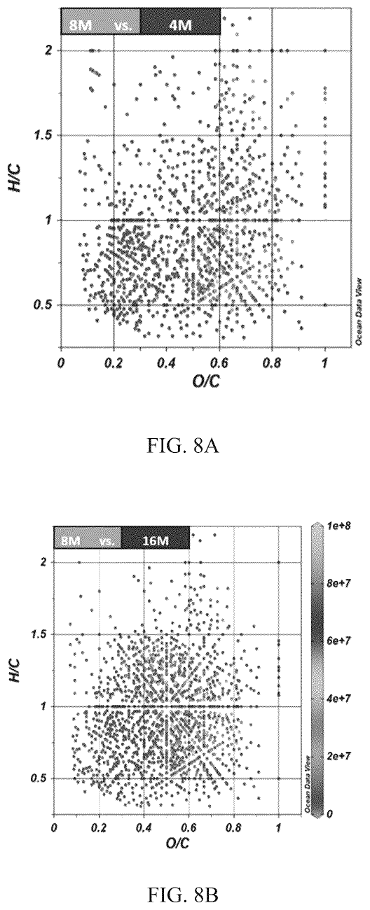

Based on the optimal values of the above various parameters (data aquisition size of 8 M, data processing size of 16 M, and starting mass-to-charge ratio of 53), the Van Krevelen diagram was drawn using the method provided in the example of the present disclosure, as shown in FIG. 8A and FIG. 8B. The differences in peak signals under the selected parameters were evaluated through the Van Krevelen diagram, and it was found that the signal diversity and throughput measured under the optimal parameter selection were significantly higher than other methods.

### Example 2

This example provided an FT-ICR mass spectrometry detection method for active dissolved organic matter, which was different from Example 1 in that the sample of Example 2 was mangrove interstitial water, and mangrove interstitial water was used for data correction in step S4.

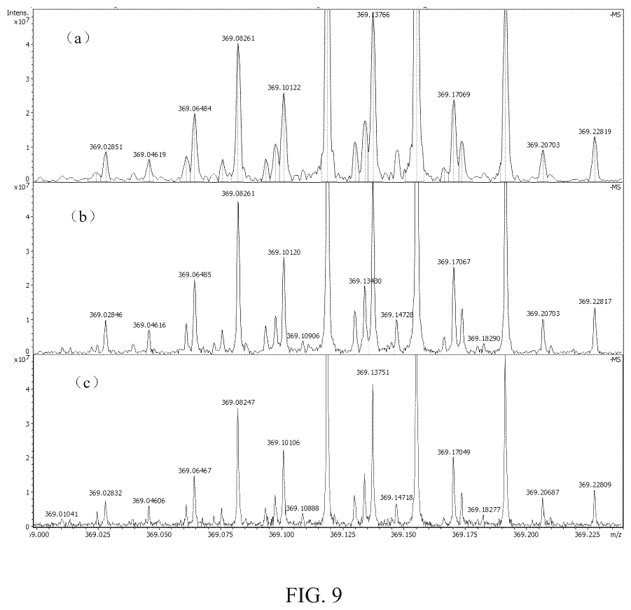

The results of Example 2 of the present disclosure will be described in detail below in conjunction with FIG. 9 to FIG. 11.

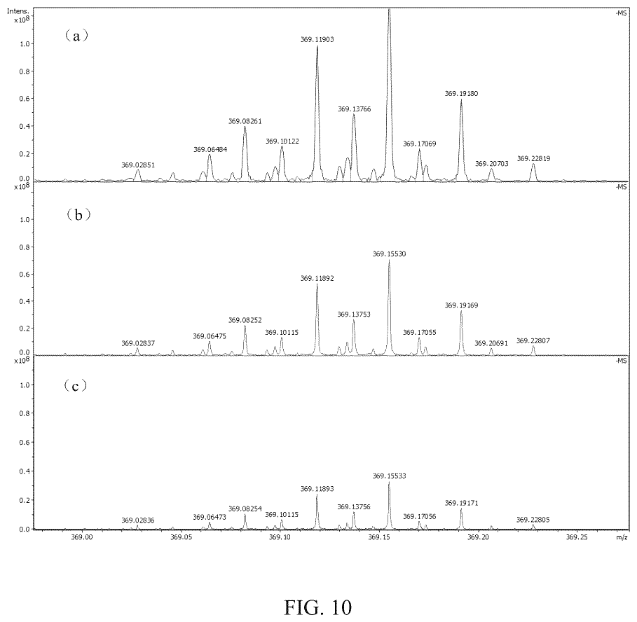

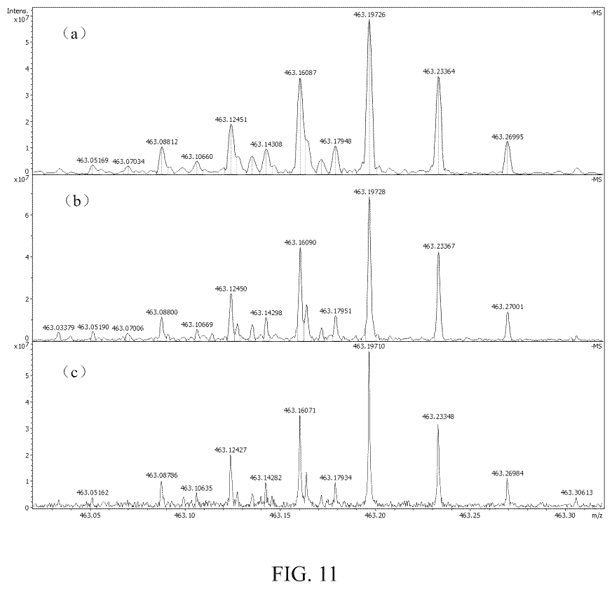

Since signals of different samples may be different, in the examples of the present disclosure, in addition to using humic acid samples, the method is also implemented on the mangrove interstitial water for verification. The results are shown in FIG. 9, FIG. 10, and FIG. 11. In FIG. 10, it can be observed that although the peak profile of the mass spectrum becomes narrower as the starting mass-to-charge ratio increases, the peak intensity of the same sample also decreases significantly. In FIG. 11, it can be observed that the peaks of polymers cannot be effectively separated at 4 M. In conjunction with FIG. 9 to FIG. 11, it can be seen that interstitial water has a greater difference in DOM signals under the optimal parameters (data aquisition size of 8 M, data processing size of 16 M, and starting mass-to-charge ratio of 53), and has better beneficial effects under the same parameter, because the interstitial water contains a large number of low-abundance ion peaks, and the dissolved organic matter therein acts as an intermediate pool for anaerobic degradation. However, these components metabolize very quickly and are difficult to detect. Therefore, this method is especially suitable for interstitial water samples, and the diversity of detected components is much higher than that of humic acid standard.

### Example 3

This example provided an FT-ICR mass spectrometry detection method for active dissolved organic matter, which was different from Example 1 in that the sample of Example 3 was seawater, and seawater was used for data correction in step 4.

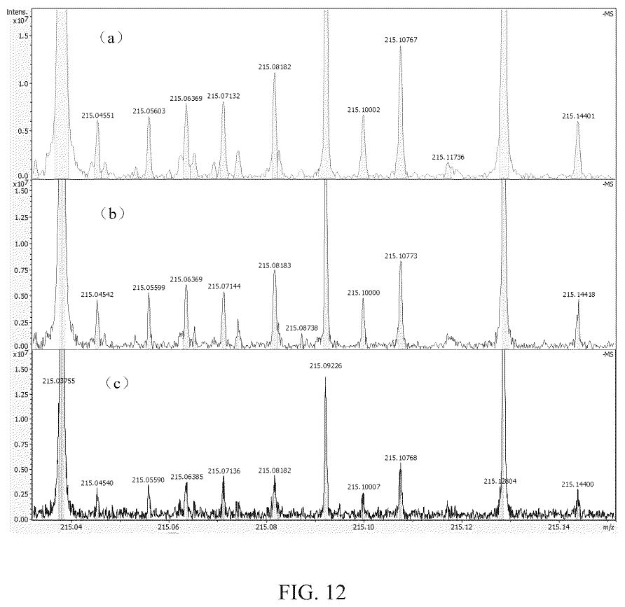

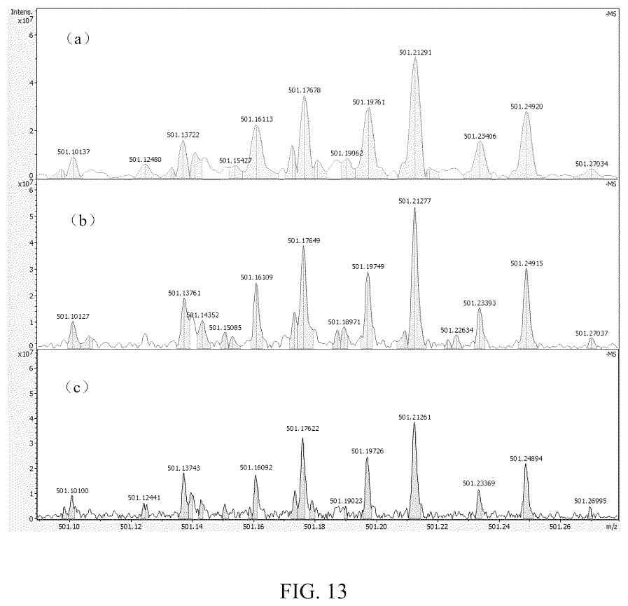

The results of Example 3 of the present disclosure will be described in detail below in conjunction with FIG. 12 and FIG. 13.

FIG. 12 is a diagram showing the quasi-molecular ion peaks of seawater obtained by means of the method provided in Example 3 of the present disclosure. It can be observed that the small molecule interval is not sensitive to the data aquisition size, but the 16 M peak suffers significant signal loss. FIG. 13 is a diagram showing the quasi-molecular ion peaks of seawater obtained by means of the method provided in Example 3 of the present disclosure. It can be observed that since the detection throughput and complexity of seawater are less than those of interstitial water, the influence of data aquisition size on DOM signals in seawater is less than that of interstitial water, and there are fewer similar peaks. It can also be seen from FIG. 12 and FIG. 13 that the best results are achieved when the data aquisition size is 8 M, the data aquisition size is 16 M, and the starting mass-to-charge ratio is 53.

### Example 4

This example provided an FT-ICR mass spectrometry detection method for active dissolved organic matter, which was different from Example 3 in that a mass spectrometer having a different magnet was used, and the magnet was 9.4 T in Example 4.

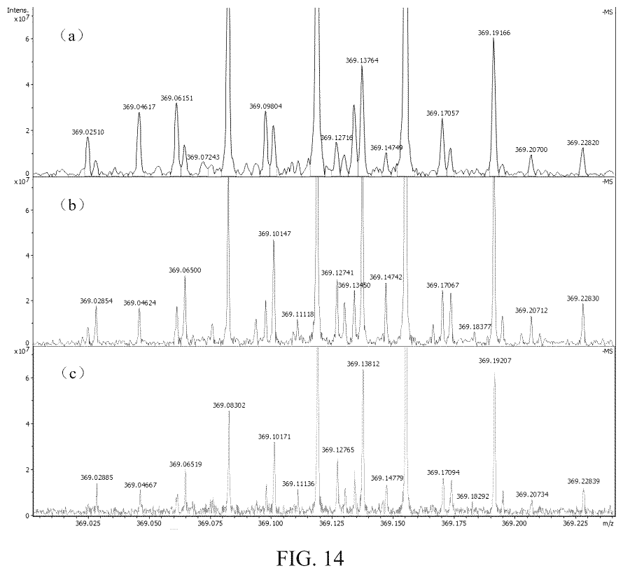

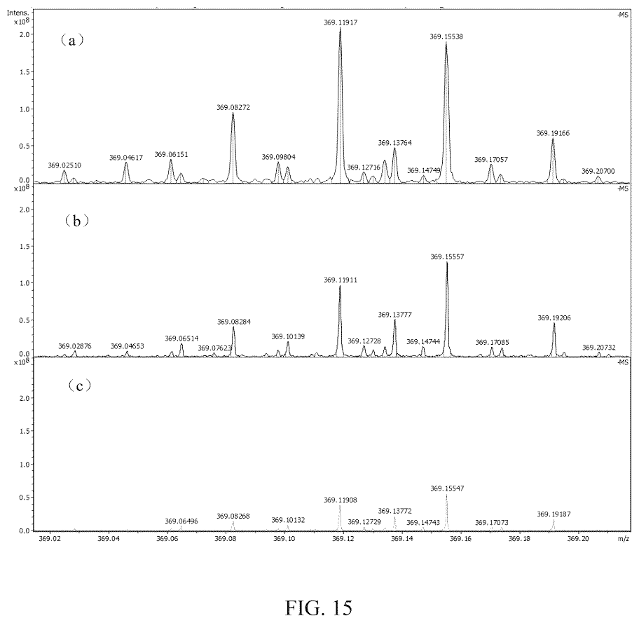

The results of Example 4 of the present disclosure will be described in detail below with conjunction with FIG. 14 and FIG. 15:

In order to verify the instruments having different magnets, especially the magnets as key components that affect peak signals, FIG. 14 and FIG. 15 provide diagrams of the quasi-molecular ion peaks of seawater obtained by using different types of instruments by means of the method provided in Example 4 of the present disclosure, with the magnet of 9.4 T. In FIG. 14, it can be observed that the optimal signal is still obtained when the data aquisition size is 8 M. In FIG. 15, it can be observed that as the starting mass-to-charge ratio increases, the ion peak increases with the resolution, but the signal intensity decreases significantly, which is the same as that of the 7 T mass spectrometer. In conjunction with FIG. 14 and FIG. 15, it can be seen that signals from different instruments show the same conclusion, indicating that the detection method proposed by the present disclosure has good universality.

A comparison of influences of different debugging parameter on specific effects in the examples of the present disclosure will be described in detail below in conjunction with the figures. The specific effect comparison is as follows.

The influences of data aquisition sizes on spectra and compound types are compared: data aquisition sizes (4 M, 8 M and 16 M) are changed to evaluate the influences of the data aquisition sizes on peak amplitude, resolution, detectable peaks and compound types. As can be seen from FIG. 3, when increasing the data aquisition size from 4 M to 8 M, the resolution and total signal intensity are significantly improved. In FIG. 4, panel (a) shows peak intensities and resolution (16 scans) obtained at a starting mass-to-charge ratio of 53 at different data aquisition sizes, and panel (b) shows a situation where 16 scans are performed from different starting mass-to-charge ratios (m/z) when the data aquisition size is 4 M. In addition, as the data aquisition size changes, the types and abundances of detectable compounds also change. When the data aquisition size is 8 M, heteroatom molecules containing nitrogen, sulfur, and phosphorus are more abundant than that when the data aquisition size is 4 M. As shown in FIG. 5B, when the data aquisition size increases from 4 M to 8 M, more peaks can be detected while improving the resolution, especially adjacent or overlapping peaks. The higher signal-to-noise ratio and intensity lead to an increase in the detection throughput of small peaks. Furthermore, the Van Krevelen diagram in FIG. 8A and FIG. 8B show an expanded range of detectable compounds, and increased diversity in compact aromatic, peptide-like, and carbohydrate-like regions. Despite this, the intensity of a peak does not increase consistently with the increase in data aquisition size. In FIG. 3, when the data aquisition size increases from 8 M to 16 M, the maximum intensity of a major peak remains similar, and the intensity of a small peak is more sensitive to the data aquisition size, resulting in a higher average intensity when the data aquisition size is 16 M than when the data aquisition size is 8 M.

In addition, it can be seen from FIG. 5A that increasing the data aquisition size leads to a change in ion distribution, apparent disappearance of low-mass and high-mass ion peaks (m/z<220; m/z>550), and loss of polyphenols and heteroatom compounds. This phenomenon can be attributed to the fact that it is difficult to sum small and sharp peaks with low peak area in multiple scans due to changes between scans, and the increased peak tip leads to more noisy peaks in the baseline. Meanwhile, when the data aquisition size is 16 M, it becomes more difficult to adjust the excitation power to stabilize low-mass and high-mass ions, so that unstable ion clouds and more noisy signals may appear, and the space charge effect under a long transient length may also suppress the signals.

In summary, it can be seen that in order to obtain better DOM fingerprints, the data aquisition size, data processing size and starting mass-to-charge ratio need to be matched. High resolution requires a stable mass-to-charge ratio and symmetrical peak profile to prevent peak splitting or shifting. Therefore, it is necessary to match the data aquisition size with other instrument parameters. The present disclosure proposes a new parameter setting strategy and method to obtain optimal peak profile and intensity.

In a specific embodiment, the technical solution of the present disclosure comprises: using 7-12 T Fourier transform resonance cyclotron mass spectrometry and negative ion scanning mode; respectively setting a data aquisition size to 8 M, a data processing size to 16 M, and an instantaneous duration to be approximately 2 s, a starting mass-to-charge ratio to be 53 m/z, and a wide spectrum scanning range to be 53 m/z to 1000 m/z; conducting scan for 200 times to obtain the spectrum and quasi-molecular ion peaks of active dissolved organic matter; and analyzing the spectrum to obtain a molecular formula, active or low-abundance dissolved organic matter signals, and detect signals of inert CRAM or humic-like substances.

The present disclosure at least achieves the following beneficial effects.

(1) Fingerprint analysis by FT-ICR-MS is successfully improved, which provides comprehensive characterization for DOM. According to the present disclosure, by using the proposed parameters, natural interstitial water samples are tested, and high-throughput spectra are obtained. The interstitial water samples are more complex and diverse than SRNOM and contain rich compounds including CHO, CHON and CHOS, which has the potential guiding significance for distinguishing sources. In addition, dissolved organic sulfur (DOS) is critical for the transport of heavy metals and sulfur cycling, so it is crucial to apply appropriate parameter matching, and instrument parameter consistency can improve the comparability of data between laboratories. Meanwhile, the present disclosure demonstrates how the data aquisition size and starting mass-to-charge ratio affect ion detection, especially the influence on heteroatom molecules, which has far-reaching significance for DOM characterization.

(2) The present disclosure is helpful to improve the guidelines for FT-ICR mass spectrometry data aquisitio and processing, enhance the reproducibility of FT-ICR-MS analysis, and improve the comparability of DOM data sets between laboratories, so that more distinctive DOM fingerprints can be obtained and more accurate analysis can be provided for the circulation of low-concentration and active compounds in water-soil-sediment systems.

(3) In the detection method of the present disclosure, the resolution is optimal. On the one hand, the situation where low-abundance signals are masked by noise is completely prevented; and on the other hand, because too high resolution is not used, the problem that signals cannot be effectively accumulated during the drift process is prevented.

(4) In the present disclosure, a specific parameter matching strategy which conforms to active dissolved organic matter is used, that is, the values of the data aquisition size, data processing size and starting mass-to-charge ratio which match each other are defined, thereby greatly increasing the detectability of active components.

(5) By means of the detection method of the present disclosure, high-throughput detection of active molecular signals that are difficult to effectively capture due to selective loss in pre-treatment can be achieved, and active and inert organic carbon components can be detected simultaneously, thereby truly establishing a bridge between a microbial carbon pump precursor and an end product. In addition, since the concentration of active components is very low and the ion signals in the mass spectrum are also very weak, small peaks are particularly sensitive to instrument parameter settings, and may be lower than the detection limit under poor settings. The parameter matching proposed by the present disclosure is conducive to improving detection throughput of rapidly circulating components.

(6) The detection method of the present disclosure is beneficial to improving the parallelism of test results. Since the peak heights of the quasi-molecular ion peaks of active dissolved organic matter vary greatly, there is a problem of instability in low-intensity signal detection, which makes it difficult to compare the results of the same sample between different laboratories or batches. By means of the detection method of the present disclosure, the stability of low-intensity signals can be improved, and the improvement of the parallelism of samples is enabled.

(7) By means of the detection method of the present disclosure, the difference between DOM after solid-phase extraction pre-treatment can be improved, thereby improving the variance to distinguish DOM components, obtaining key signals and signal differences with discrimination, and preventing the problem of being unable to distinguish true differences between samples due to a large number of similar signals. The DOM in natural water bodies has a high degree of similarity, which is particularly important for the detection of DOM samples.

(8) By means of the detection method of the present disclosure, appropriate resolution is obtained through the mutual matching of the data aquisition size, data processing size, and starting mass-to-charge ratio, the shift of the mass-to-charge ratio is reduced, the half-peak width is reduced, the position of the peak is determined more accurately, and lost components or incorrect molecular formulas are reduced.

The above examples are preferred examples of the present disclosure, but the examples of the present disclosure are not limited to the above examples. Any other changes, modifications, substitutions, combinations and simplifications made without departing from the gist and principle of the present disclosure shall be equivalent replacement methods, and shall be included in the protection scope of the present disclosure.

1. A Fourier transform ion cyclotron resonance (FT-ICR) mass spectrometry detection method for active dissolved organic matter, comprising the following steps:
S1. injecting a sample to be tested into an atomizer;
S2. setting detection parameters of the FT-ICR mass spectrometry and conducting a test, wherein a data aquisition size is set to 4 M to 8 M, a data processing size is set to 8 M to 16 M, and a starting mass-to-charge ratio is set to 50 to 200; and
S3. obtaining a mass spectrum and quasi-molecular ion peaks.

2. The detection method according to claim 1, wherein the sample to be tested in the step S1 is obtained from at least one of water, soil and sediment.

3. The detection method according to claim 1, wherein the sample to be tested in the step S1 is injected into the atomizer at a syringe flow rate of 195 μL/h to 205 μL/h.

4. The detection method according to claim 1, wherein the starting mass-to-charge ratio in the step S2 is set to 50 to 60.

5. The detection method according to claim 4, wherein the data aquisition size in the step S2 is set to 8 M; and the data processing size in the step S2 is set to 16 M.

6. The detection method according to claim 1, wherein an instantaneous duration of a single scan in the test in the step S2 is 1.5 s to 2.5 s.

7. The detection method according to claim 1, wherein a sweep excitation power in the test in the step S2 is 17% to 23%.

8. The detection method according to claim 1, wherein the data aquisition in the step S2 is conducted through mass spectrometry; and a mode of the data aquisition is a broadband mode; and/or,
the broadband mode has a scanning range of 50 m/z to 1000 m/z.

9. The detection method according to claim 1, further comprising an operation for a secondary verification of if there is an overload in a total ion flow of an ion source and/or an operation for peak branching debugging between the step S2 and step S3; and/or
the step S3 further comprises deriving the quasi-molecular ion peaks for data correction and molecular formula analysis.

10. The detection method according to claim 9, wherein the data correction is performed using a standard peak of the sample to be tested.

11. The detection method according to claim 2, wherein the sample to be tested in the step S1 is injected into the atomizer at a syringe flow rate of 195 μL/h to 205 μL/h.

12. The detection method according to claim 5, wherein an instantaneous duration of a single scan in the test in the step S2 is 1.5 s to 2.5 s.

13. The detection method according to claim 1, wherein the sample to be tested in the step S1 is one of humic acid, interstitial water and seawater.

14. The detection method according to claim 1, wherein the sample to be tested in the step S1 has an initial concentration of 21 mgC/L to 22 mgC/L.

15. The detection method according to claim 1, wherein a gas pressure of the atomizer in the step S1 is set to 0.7 bar to 0.9 bar.

16. The detection method according to claim 1, wherein operating conditions of a dry gas in the atomizer of step S1 are 195° C. to 205° C., and 3 L/min to 5 L/min.

17. The detection method according to claim 1, wherein the test in the step S2 is a purge operation.

18. The detection method according to claim 1, wherein the test in the step S2 is scanned for 16 times to 200 times.

19. The detection method according to claim 1, wherein the test in the step S2 has a capillary voltage of 4 kV to 5 kV.

20. The detection method according to claim 1, wherein each scan in the test has an ion accumulation time of 0.02 s to 0.08 s.
